(19) United States
(12) Patent Application Publication
(10) Pub. No.: US 2023/0297607 A1
(43) Pub. Date: Sep. 21, 2023

(54) METHOD AND DEVICE FOR PRESENTING CONTENT BASED ON MACHINE-READABLE CONTENT AND OBJECT TYPE

(71) Applicant: Apple Inc., Cupertino, CA (US)

(72) Inventors: Thomas G. Salter, Foster City, CA (US); Christopher D. Fu, Fremont, CA (US); Devin W. Chalmers, Oakland, CA (US); Paulo R. Jansen dos Reis, San Jose, CA (US)

(21) Appl. No.: 18/121,988

(22) Filed: Mar. 15, 2023

Related U.S. Application Data
(63) Continuation of application No. PCT/US2021/049434, filed on Sep. 8, 2021.
(60) Provisional application No. 63/082,953, filed on Sep. 24, 2020.

(51) Int. Cl. G06F 16/438; G06F 16/432

(52) U.S. Cl. CPC G06F 16/438; G06F 16/434

(57) ABSTRACT

In one implementation, a method of presenting virtual content is performed by a device including an image sensor, one or more processors, and non-transitory memory. The method includes obtaining, using the image sensor, an image of a physical environment. The method includes detecting, in the image of the physical environment, machine-readable content associated with an object. The method includes determining an object type of the object. The method includes obtaining virtual content based on a search query creating using the machine-readable content and the object type. The method includes displaying the virtual content.

### CROSS-REFERENCE TO RELATED APPLICATIONS

This application is a continuation of Intl. Patent App. No. PCT/US2021/049434, filed on Sep. 8, 2021, which claims priority to U.S. Provisional Patent App. No. 63/082,953, filed on Sep. 24, 2020, which are both hereby incorporated by reference in their entirety.

### TECHNICAL FIELD

The present disclosure generally relates to systems, methods, and devices for presenting virtual content to a user, and in particular, relates to presenting virtual content to a user based on a search query created using machine-readable content associated with an object and an object type of the object.

### BACKGROUND

In various implementations, an electronic device displays virtual content based on objects in the physical environment. In various implementations, the virtual content is based on text printed on an object detected in an image of the physical environment. However, in various implementations, the text may be ambiguous, referring alternatively to one of a plurality of different subjects. Accordingly, virtual content based on the text may not accurately correspond to the subject to which the text refers.

### BRIEF DESCRIPTION OF THE DRAWINGS

So that the present disclosure can be understood by those of ordinary skill in the art, a more detailed description may be had by reference to aspects of some illustrative implementations, some of which are shown in the accompanying drawings.

FIG. 1 is a block diagram of an example operating environment in accordance with some implementations.

FIG. 2 is a block diagram of an example controller in accordance with some implementations.

FIG. 3 is a block diagram of an example electronic device in accordance with some implementations.

FIGS. 4A-4J illustrate an XR environment based on a physical environment including a plurality of objects associated with machine-readable content.

FIG. 5 is a flowchart representation of a method of presenting virtual content in accordance with some implementations.

In accordance with common practice the various features illustrated in the drawings may not be drawn to scale. Accordingly, the dimensions of the various features may be arbitrarily expanded or reduced for clarity. In addition, some of the drawings may not depict all of the components of a given system, method or device. Finally, like reference numerals may be used to denote like features throughout the specification and figures.

### SUMMARY

Various implementations disclosed herein include devices, systems, and methods for presenting virtual content. In various implementations, the method is performed by a device including an image sensor, one or more processors, and non-transitory memory. The method includes obtaining, using the image sensor, an image of a physical environment. The method includes detecting, in the image of the physical environment, machine-readable content associated with an object. The method includes determining an object type of the object. The method includes obtaining virtual content based on a search query created using the machine-readable content and the object type. The method includes displaying the virtual content.

In accordance with some implementations, a device includes one or more processors, a non-transitory memory, and one or more programs; the one or more programs are stored in the non-transitory memory and configured to be executed by the one or more processors. The one or more programs include instructions for performing or causing performance of any of the methods described herein. In accordance with some implementations, a non-transitory computer readable storage medium has stored therein instructions, which, when executed by one or more processors of a device, cause the device to perform or cause performance of any of the methods described herein. In accordance with some implementations, a device includes: one or more processors, a non-transitory memory, and means for performing or causing performance of any of the methods described herein.

### DESCRIPTION

A physical environment refers to a physical place that people can sense and/or interact with without aid of electronic devices. The physical environment may include physical features such as a physical surface or a physical object. For example, the physical environment corresponds to a physical park that includes physical trees, physical buildings, and physical people. People can directly sense and/or interact with the physical environment such as through sight, touch, hearing, taste, and smell. In contrast, an extended reality (XR) environment refers to a wholly or partially simulated environment that people sense and/or interact with via an electronic device. For example, the XR environment may include augmented reality (AR) content, mixed reality (MR) content, virtual reality (VR) content, and/or the like. With an XR system, a subset of a person's physical motions, or representations thereof, are tracked, and, in response, one or more characteristics of one or more virtual objects simulated in the XR environment are adjusted in a manner that comports with at least one law of physics. As an example, the XR system may detect movement of the electronic device presenting the XR environment (e.g., a mobile phone, a tablet, a laptop, a head-mounted device, and/or the like) and, in response, adjust graphical content and an acoustic field presented by the electronic device to the person in a manner similar to how such views and sounds would change in a physical environment. In some situations (e.g., for accessibility reasons), the XR system may adjust characteristic(s) of graphical content in the XR environment in response to representations of physical motions (e.g., vocal commands).

There are many different types of electronic systems that enable a person to sense and/or interact with various XR environments. Examples include head-mountable systems, projection-based systems, heads-up displays (HUDs), vehicle windshields having integrated display capability, windows having integrated display capability, displays formed as lenses designed to be placed on a person's eyes (e.g., similar to contact lenses), headphones/earphones, speaker arrays, input systems (e.g., wearable or handheld controllers with or without haptic feedback), smartphones, tablets, and desktop/laptop computers. A head-mountable system may have one or more speaker(s) and an integrated opaque display. Alternatively, a head-mountable system may be configured to accept an external opaque display (e.g., a smartphone). The head-mountable system may incorporate one or more imaging sensors to capture images or video of the physical environment, and/or one or more microphones to capture audio of the physical environment. Rather than an opaque display, a head-mountable system may have a transparent or translucent display. The transparent or translucent display may have a medium through which light representative of images is directed to a person's eyes. The display may utilize digital light projection, OLEDs, LEDs, uLEDs, liquid crystal on silicon, laser scanning light sources, or any combination of these technologies. The medium may be an optical waveguide, a hologram medium, an optical combiner, an optical reflector, or any combination thereof. In some implementations, the transparent or translucent display may be configured to become opaque selectively. Projection-based systems may employ retinal projection technology that projects graphical images onto a person's retina. Projection systems also may be configured to project virtual objects into the physical environment, for example, as a hologram or on a physical surface.

Numerous details are described in order to provide a thorough understanding of the example implementations shown in the drawings. However, the drawings merely show some example aspects of the present disclosure and are therefore not to be considered limiting. Those of ordinary skill in the art will appreciate that other effective aspects and/or variants do not include all of the specific details described herein. Moreover, well-known systems, methods, components, devices, and circuits have not been described in exhaustive detail so as not to obscure more pertinent aspects of the example implementations described herein.

In various implementations, an object in a physical environment is associated with text or data encoded in another machine-readable format, such as a barcode. For example, in various implementations, the text is printed on the object. An electronic device detects the text and obtains virtual content based on the text. In various implementations, the text may ambiguously refer to one of a plurality of different subjects. For example, “orange” may refer to the fruit or the color. As another example, a body part name may refer to the body part or a movie named after the body part. As another example, a place name (such as the name of a city, state, or country) may refer to the place or a band named after the place. Accordingly, in various implementations, the electronic device determines an object type of the object to disambiguate between the various subjects and obtain relevant virtual content. For example, text printed on an object determined to be a record album is more likely to refer to the band than the place after which the band is named.

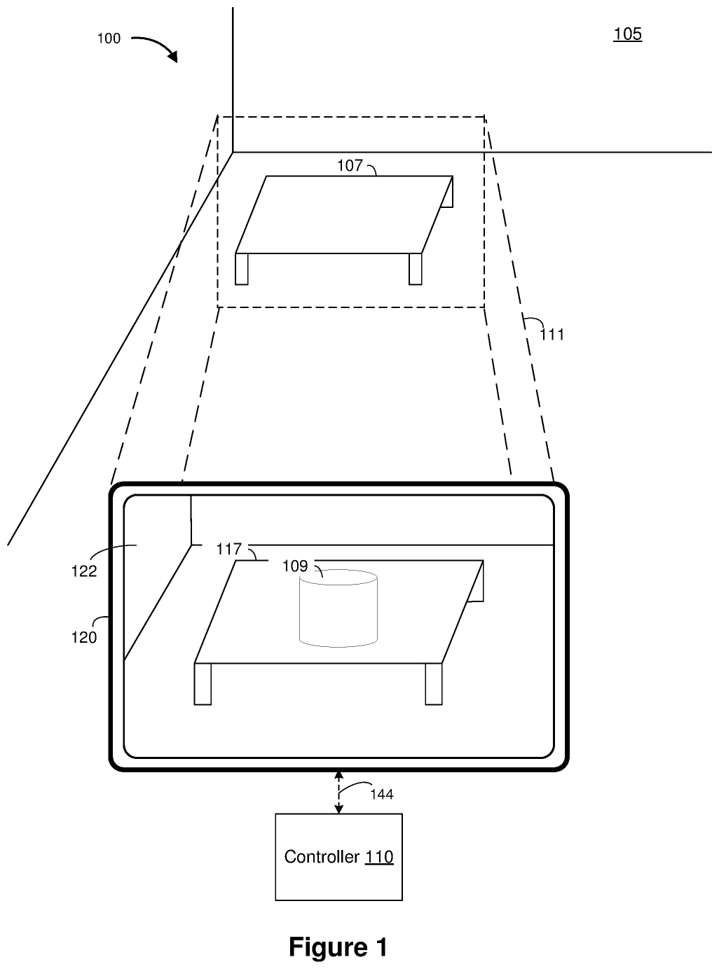

FIG. 1 is a block diagram of an example operating environment 100 in accordance with some implementations. While pertinent features are shown, those of ordinary skill in the art will appreciate from the present disclosure that various other features have not been illustrated for the sake of brevity and so as not to obscure more pertinent aspects of the example implementations disclosed herein. To that end, as a non-limiting example, the operating environment 100 includes a controller 110 and an electronic device 120.

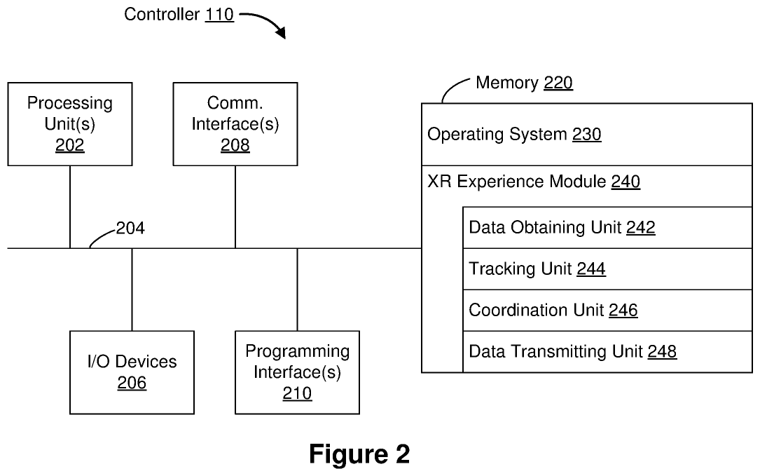

In some implementations, the controller 110 is configured to manage and coordinate an XR experience for the user. In some implementations, the controller 110 includes a suitable combination of software, firmware, and/or hardware. The controller 110 is described in greater detail below with respect to FIG. 2. In some implementations, the controller 110 is a computing device that is local or remote relative to the physical environment 105. For example, the controller 110 is a local server located within the physical environment 105. In another example, the controller 110 is a remote server located outside of the physical environment 105 (e.g., a cloud server, central server, etc.). In some implementations, the controller 110 is communicatively coupled with the electronic device 120 via one or more wired or wireless communication channels 144 (e.g., BLUETOOTH, IEEE 802.11x, IEEE 802.16x, IEEE 802.3x, etc.). In another example, the controller 110 is included within the enclosure of the electronic device 120. In some implementations, the functionalities of the controller 110 are provided by and/or combined with the electronic device 120.

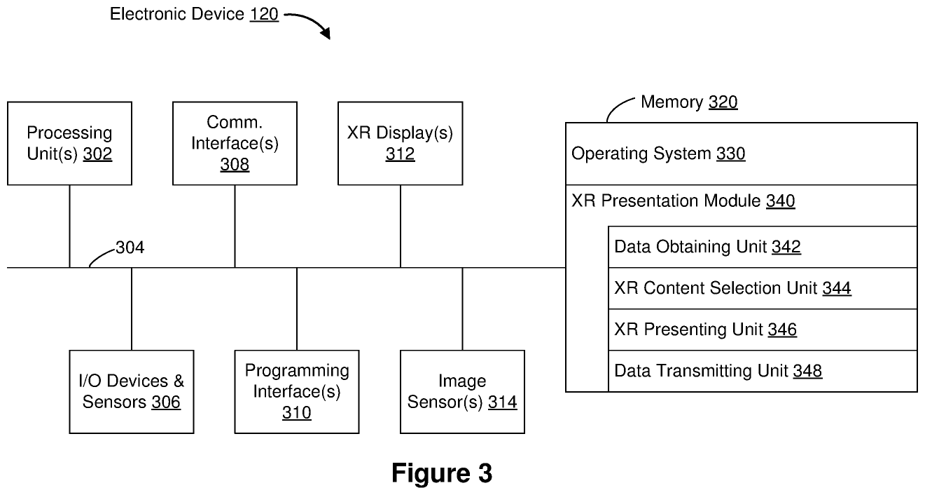

In some implementations, the electronic device 120 is configured to provide the XR experience to the user. In some implementations, the electronic device 120 includes a suitable combination of software, firmware, and/or hardware. According to some implementations, the electronic device 120 presents, via a display 122, XR content to the user while the user is physically present within the physical environment 105 that includes a table 107 within the field-of-view 111 of the electronic device 120. As such, in some implementations, the user holds the electronic device 120 in his/her hand(s). In some implementations, while providing XR content, the electronic device 120 is configured to display an XR object (e.g., an XR cylinder 109) and to enable video pass-through of the physical environment 105 (e.g., including a representation 117 of the table 107) on a display 122. The electronic device 120 is described in greater detail below with respect to FIG. 3.

According to some implementations, the electronic device 120 provides an XR experience to the user while the user is virtually and/or physically present within the physical environment 105.

In some implementations, the user wears the electronic device 120 on his/her head. For example, in some implementations, the electronic device includes a head-mounted system (HMS), head-mounted device (HMD), or head-mounted enclosure (HME). As such, the electronic device 120 includes one or more XR displays provided to display the XR content. For example, in various implementations, the electronic device 120 encloses the field-of-view of the user. In some implementations, the electronic device 120 is a handheld device (such as a smartphone or tablet) configured to present XR content, and rather than wearing the electronic device 120, the user holds the device with a display directed towards the field-of-view of the user and a camera directed towards the physical environment 105. In some implementations, the handheld device can be placed within an enclosure that can be worn on the head of the user. In some implementations, the electronic device 120 is replaced with an XR chamber, enclosure, or room configured to present XR content in which the user does not wear or hold the electronic device 120.

FIG. 2 is a block diagram of an example of the controller 110 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the controller 110 includes one or more processing units 202 (e.g., microprocessors, application-specific integrated-circuits (ASICs), field-programmable gate arrays (FPGAs), graphics processing units (GPUs), central processing units (CPUs), processing cores, and/or the like), one or more input/output (I/O) devices 206, one or more communication interfaces 208 (e.g., universal serial bus (USB), FIREWIRE, THUNDERBOLT, IEEE 802.3x, IEEE 802.11x, IEEE 802.16x, global system for mobile communications (GSM), code division multiple access (CDMA), time division multiple access (TDMA), global positioning system (GPS), infrared (IR), BLUETOOTH, ZIGBEE, and/or the like type interface), one or more programming (e.g., I/O) interfaces 210, a memory 220, and one or more communication buses 204 for interconnecting these and various other components.

In some implementations, the one or more communication buses 204 include circuitry that interconnects and controls communications between system components. In some implementations, the one or more I/O devices 206 include at least one of a keyboard, a mouse, a touchpad, a joystick, one or more microphones, one or more speakers, one or more image sensors, one or more displays, and/or the like.

The memory 220 includes high-speed random-access memory, such as dynamic random-access memory (DRAM), static random-access memory (SRAM), double-data-rate random-access memory (DDR RAM), or other random-access solid-state memory devices. In some implementations, the memory 220 includes non-volatile memory, such as one or more magnetic disk storage devices, optical disk storage devices, flash memory devices, or other non-volatile solid-state storage devices. The memory 220 optionally includes one or more storage devices remotely located from the one or more processing units 202. The memory 220 comprises a non-transitory computer readable storage medium. In some implementations, the memory 220 or the non-transitory computer readable storage medium of the memory 220 stores the following programs, modules and data structures, or a subset thereof including an optional operating system 230 and an XR experience module 240.

The operating system 230 includes procedures for handling various basic system services and for performing hardware dependent tasks. In some implementations, the XR experience module 240 is configured to manage and coordinate one or more XR experiences for one or more users (e.g., a single XR experience for one or more users, or multiple XR experiences for respective groups of one or more users). To that end, in various implementations, the XR experience module 240 includes a data obtaining unit 242, a tracking unit 244, a coordination unit 246, and a data transmitting unit 248.

In some implementations, the data obtaining unit 242 is configured to obtain data (e.g., presentation data, interaction data, sensor data, location data, etc.) from at least the electronic device 120 of FIG. 1. To that end, in various implementations, the data obtaining unit 242 includes instructions and/or logic therefor, and heuristics and metadata therefor.

In some implementations, the tracking unit 244 is configured to map the physical environment 105 and to track the position/location of at least the electronic device 120 with respect to the physical environment 105 of FIG. 1. To that end, in various implementations, the tracking unit 244 includes instructions and/or logic therefor, and heuristics and metadata therefor.

In some implementations, the coordination unit 246 is configured to manage and coordinate the XR experience presented to the user by the electronic device 120. To that end, in various implementations, the coordination unit 246 includes instructions and/or logic therefor, and heuristics and metadata therefor.

In some implementations, the data transmitting unit 248 is configured to transmit data (e.g., presentation data, location data, etc.) to at least the electronic device 120. To that end, in various implementations, the data transmitting unit 248 includes instructions and/or logic therefor, and heuristics and metadata therefor.

Although the data obtaining unit 242, the tracking unit 244, the coordination unit 246, and the data transmitting unit 248 are shown as residing on a single device (e.g., the controller 110), it should be understood that in other implementations, any combination of the data obtaining unit 242, the tracking unit 244, the coordination unit 246, and the data transmitting unit 248 may be located in separate computing devices.

Moreover, FIG. 2 is intended more as functional description of the various features that may be present in a particular implementation as opposed to a structural schematic of the implementations described herein. As recognized by those of ordinary skill in the art, items shown separately could be combined and some items could be separated. For example, some functional modules shown separately in FIG. 2 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

FIG. 3 is a block diagram of an example of the electronic device 120 in accordance with some implementations. While certain specific features are illustrated, those skilled in the art will appreciate from the present disclosure that various other features have not been illustrated for the sake of brevity, and so as not to obscure more pertinent aspects of the implementations disclosed herein. To that end, as a non-limiting example, in some implementations the electronic device 120 includes one or more processing units 302 (e.g., microprocessors, ASICs, FPGAs, GPUs, CPUs, processing cores, and/or the like), one or more input/output (I/O) devices and sensors 306, one or more communication interfaces 308 (e.g., USB, FIREWIRE, THUNDERBOLT, IEEE 802.3x, IEEE 802.11x, IEEE 802.16x, GSM, CDMA, TDMA, GPS, IR, BLUETOOTH, ZIGBEE, and/or the like type interface), one or more programming (e.g., I/O) interfaces 310, one or more XR displays 312, one or more optional interior- and/or exterior-facing image sensors 314, a memory 320, and one or more communication buses 304 for interconnecting these and various other components.

In some implementations, the one or more communication buses 304 include circuitry that interconnects and controls communications between system components. In some implementations, the one or more I/O devices and sensors 306 include at least one of an inertial measurement unit (IMU), an accelerometer, a gyroscope, a thermometer, one or more physiological sensors (e.g., blood pressure monitor, heart rate monitor, blood oxygen sensor, blood glucose sensor, etc.), one or more microphones, one or more speakers, a haptics engine, one or more depth sensors (e.g., a structured light, a time-of-flight, or the like), and/or the like.

In some implementations, the one or more XR displays 312 are configured to provide the XR experience to the user. In some implementations, the one or more XR displays 312 correspond to holographic, digital light processing (DLP), liquid-crystal display (LCD), liquid-crystal on silicon (LCoS), organic light-emitting field-effect transitory (OLET), organic light-emitting diode (OLED), surface-conduction electron-emitter display (SED), field-emission display (FED), quantum-dot light-emitting diode (QD-LED), micro-electro-mechanical system (MEMS), and/or the like display types. In some implementations, the one or more XR displays 312 correspond to diffractive, reflective, polarized, holographic, etc. waveguide displays. For example, the electronic device 120 includes a single XR display. In another example, the electronic device includes an XR display for each eye of the user. In some implementations, the one or more XR displays 312 are capable of presenting MR and VR content.

In some implementations, the one or more image sensors 314 are configured to obtain image data that corresponds to at least a portion of the face of the user that includes the eyes of the user (any may be referred to as an eye-tracking camera). In some implementations, the one or more image sensors 314 are configured to be forward-facing so as to obtain image data that corresponds to the scene as would be viewed by the user if the electronic device 120 was not present (and may be referred to as a scene camera). The one or more optional image sensors 314 can include one or more RGB cameras (e.g., with a complimentary metal-oxide-semiconductor (CMOS) image sensor or a charge-coupled device (CCD) image sensor), one or more infrared (IR) cameras, one or more event-based cameras, and/or the like.

The memory 320 includes high-speed random-access memory, such as DRAM, SRAM, DDR RAM, or other random-access solid-state memory devices. In some implementations, the memory 320 includes non-volatile memory, such as one or more magnetic disk storage devices, optical disk storage devices, flash memory devices, or other non-volatile solid-state storage devices. The memory 320 optionally includes one or more storage devices remotely located from the one or more processing units 302. The memory 320 comprises a non-transitory computer readable storage medium. In some implementations, the memory 320 or the non-transitory computer readable storage medium of the memory 320 stores the following programs, modules and data structures, or a subset thereof including an optional operating system 330 and an XR presentation module 340.

The operating system 330 includes procedures for handling various basic system services and for performing hardware dependent tasks. In some implementations, the XR presentation module 340 is configured to present XR content to the user via the one or more XR displays 312. To that end, in various implementations, the XR presentation module 340 includes a data obtaining unit 342, an XR content selection unit 344, an XR presenting unit 346, and a data transmitting unit 348.

In some implementations, the data obtaining unit 342 is configured to obtain data (e.g., presentation data, interaction data, sensor data, location data, etc.) from at least the controller 110 of FIG. 1. To that end, in various implementations, the data obtaining unit 342 includes instructions and/or logic therefor, and heuristics and metadata therefor.

In some implementations, the XR content selection unit 344 is configured to obtain content based on machine-readable content associated with an object and an object type of the object. To that end, in various implementations, the XR content selection unit 344 includes instructions and/or logic therefor, and heuristics and metadata therefor.

In some implementations, the XR presenting unit 346 is configured to provide feedback regarding the plurality of temporal metrics via the one or more XR displays 312. To that end, in various implementations, the XR presenting unit 346 includes instructions and/or logic therefor, and heuristics and metadata therefor.

In some implementations, the data transmitting unit 348 is configured to transmit data (e.g., presentation data, location data, etc.) to at least the controller 110. In some implementations, the data transmitting unit 348 is configured to transmit authentication credentials to the electronic device. To that end, in various implementations, the data transmitting unit 348 includes instructions and/or logic therefor, and heuristics and metadata therefor.

Although the data obtaining unit 342, the XR content selection unit 344, the XR presenting unit 346, and the data transmitting unit 348 are shown as residing on a single device (e.g., the electronic device 120), it should be understood that in other implementations, any combination of the data obtaining unit 342, the XR content selection unit 344, the XR presenting unit 346, and the data transmitting unit 348 may be located in separate computing devices.

Moreover, FIG. 3 is intended more as a functional description of the various features that could be present in a particular implementation as opposed to a structural schematic of the implementations described herein. As recognized by those of ordinary skill in the art, items shown separately could be combined and some items could be separated. For example, some functional modules shown separately in FIG. 3 could be implemented in a single module and the various functions of single functional blocks could be implemented by one or more functional blocks in various implementations. The actual number of modules and the division of particular functions and how features are allocated among them will vary from one implementation to another and, in some implementations, depends in part on the particular combination of hardware, software, and/or firmware chosen for a particular implementation.

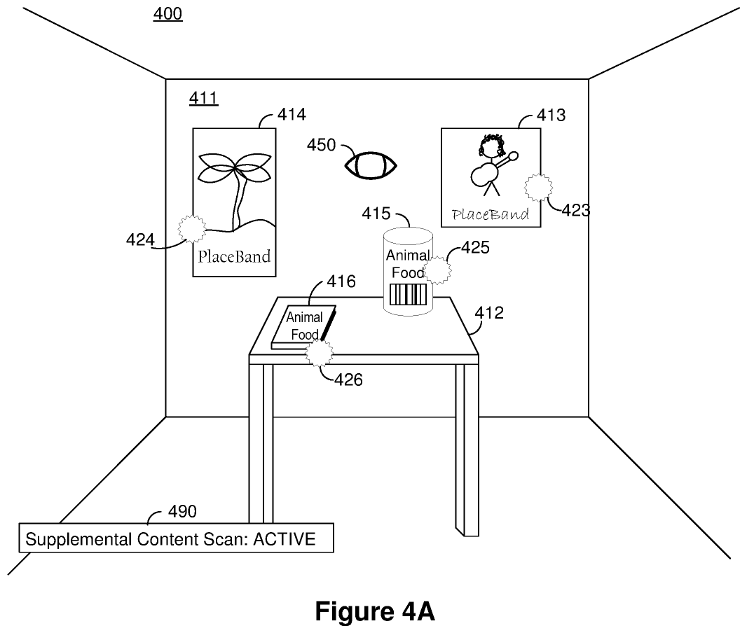

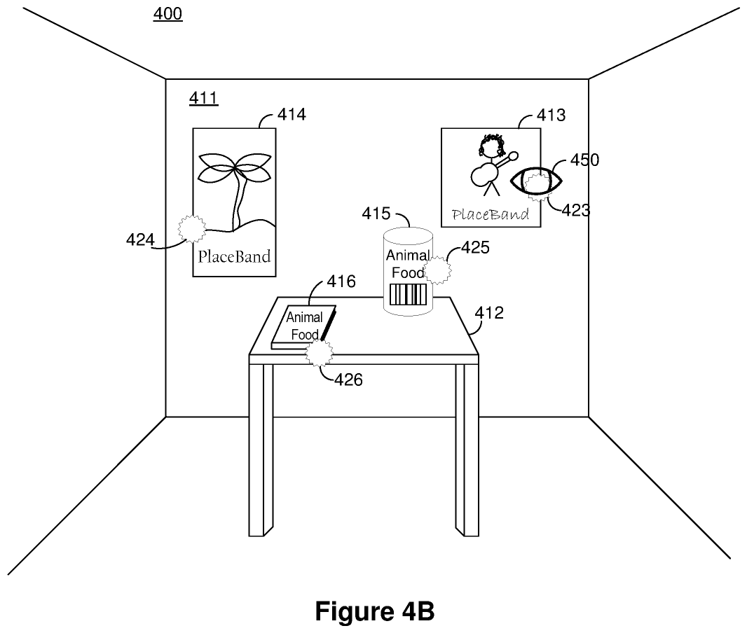

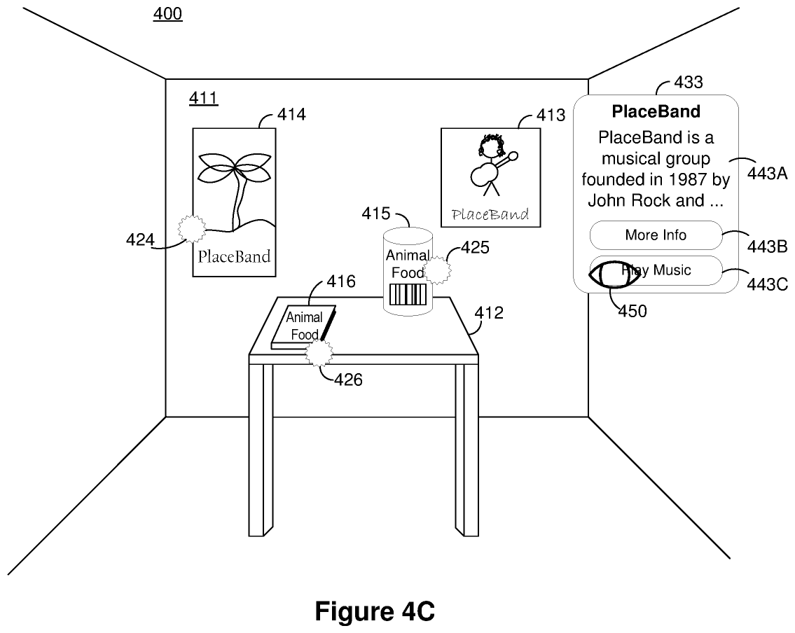

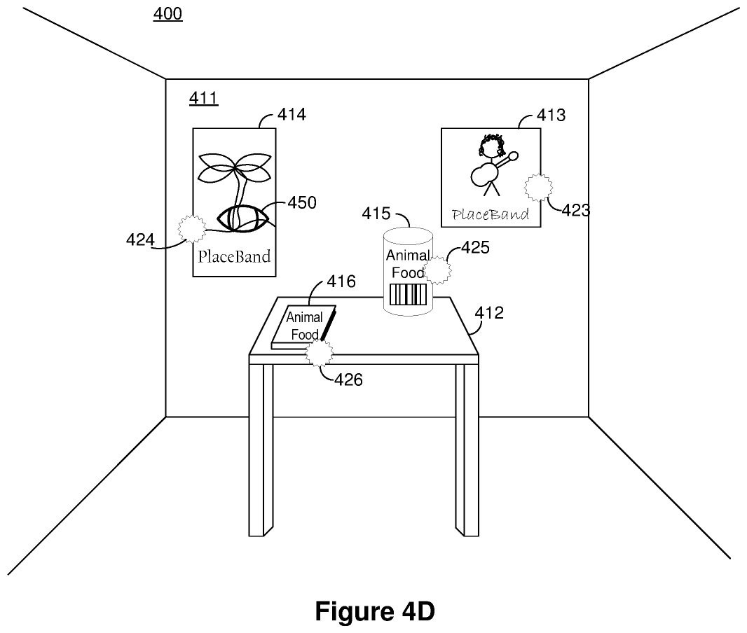

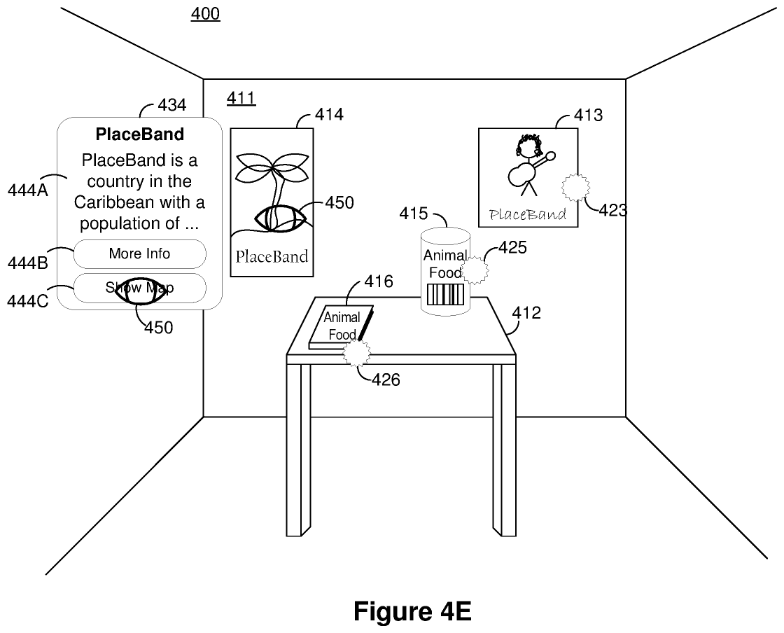

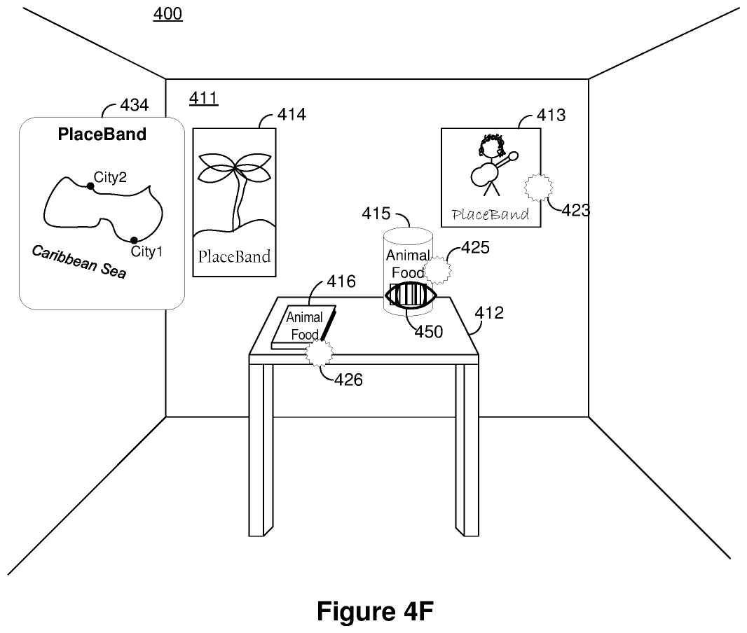

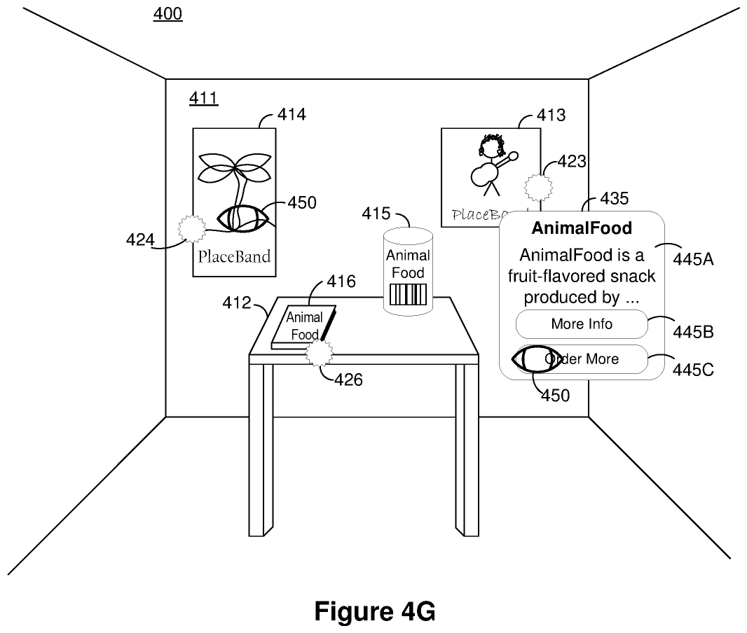

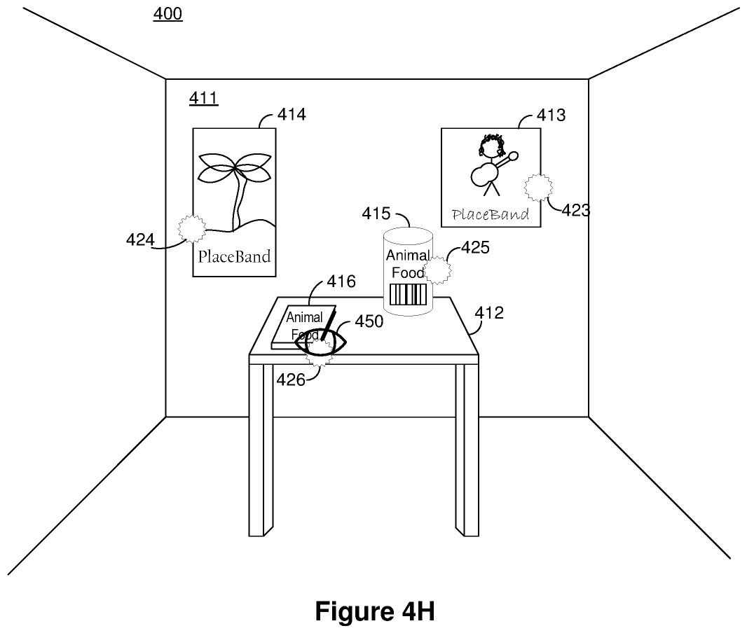

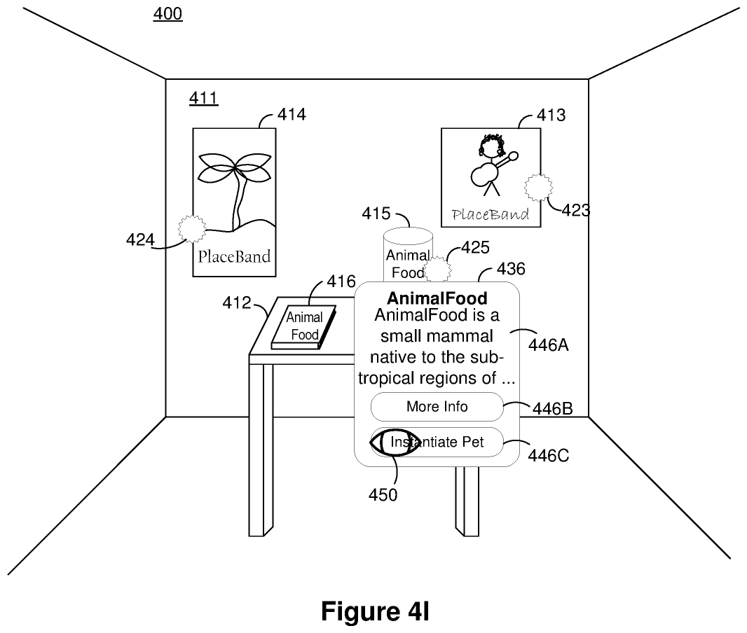

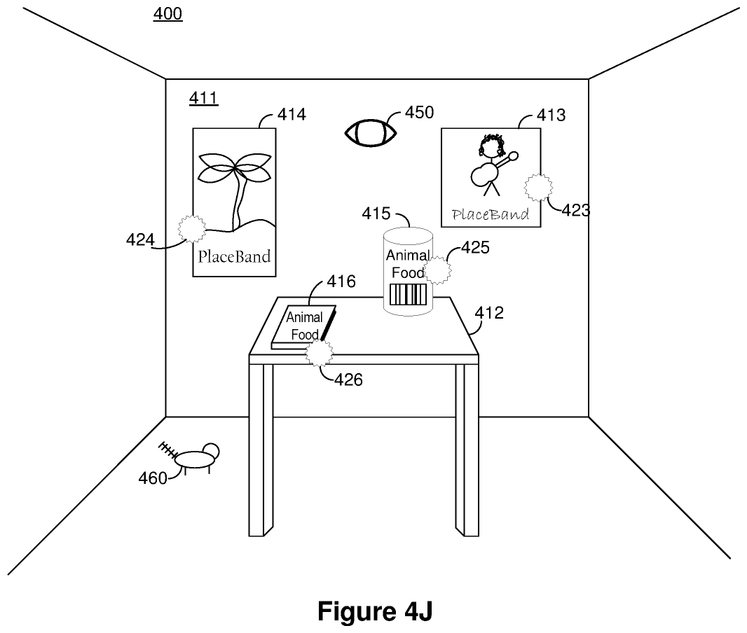

FIGS. 4A-4J illustrate an XR environment 400 based on a physical environment including a plurality of objects associated with machine-readable content. FIGS. 4A-4J illustrate the XR environment 400 from the perspective of a user. In various implementations, the perspective of the user is from a location of an image sensor of an electronic device. For example, in various implementations, the electronic device is a handheld electronic device and the perspective of the user is from a location of the image sensor of the handheld electronic device directed towards the physical environment. In various implementations, the perspective of the user is from the location of a user of the electronic device. For example, in various implementations, the electronic device is a head-mounted electronic device and the perspective of the user is from a location of the user directed towards the physical environment, generally approximating the field-of-view of the user were the head-mounted electronic device not present. In various implementations, the perspective of the user is from the location of an avatar of the user. For example, in various implementations, the XR environment 400 is a virtual environment and the perspective of the user is from location of an avatar or other representation of the user directed towards the virtual environment.

FIG. 4A illustrates the XR environment 400 during a first time period. In various implementations, the first time period is an instant, a fraction of a second, a few seconds, a few hours, a few days, or any length of time. During the first time period, the XR environment 400 includes a plurality of objects, including one or more real objects (e.g., a wall 411, a table 412, a record album 413, a travel poster 414, a snack canister 415, and a book 416) and one or more virtual objects (e.g., a plurality of content indicators 423-426, a gaze direction indicator 450, and a scan indicator 490). In various implementations, certain objects (such as the real objects 411-416 and the content indicators 423-426) are displayed at a location in the XR environment 400, e.g., at a location defined by three coordinates in a three-dimensional (3D) XR coordinate system. Accordingly, when the user moves in the XR environment 400 (e.g., changes either position and/or orientation), the objects are moved on the display of the device, but retain their location in the XR environment 400. In various implementations, certain virtual objects (such as the scan indicator 490) are displayed at locations on the display such that when the user moves in the XR environment 400, the objects are stationary on the display on the device.

The XR environment 400 includes a scan indicator 490. At the first time, the scan indicator 490 indicates that a scanning mode is active. In various implementations, a user can activate or deactivate the scanning mode. When the scanning mode is active, the electronic device scans an image of the physical environment to detect machine-readable content associated with objects in the physical environment. In various implementations, the electronic device scans the entire image of the physical environment to detect machine-readable content associated with objects in the physical environment. In various implementations, the electronic device scans a portion of the image around a gaze of the user.

In response to detecting machine-readable content associated with an object, the electronic device obtains virtual content based on the machine-readable content. In various implementations, the electronic device determines an object type of the object and disambiguates the machine-readable content based on an object type. Thus, in various implementations, the electronic device obtains virtual content based on the machine-readable content and the object type.

FIG. 4A illustrates a first content indicator 423 indicating that the electronic device has identified content related to the record album 413. In various implementations, the electronic device detects the text printed on the record album 413. In various implementations, the text (e.g., “PlaceBand”) alternatively refers to a band or a place. In response to determining that the text is printed on an object having an object type of “record album”, the electronic device identifies content relating to the band named “PlaceBand” rather than the place named “PlaceBand”.

FIG. 4A illustrates a second content indicator 424 indicating that the electronic device has identified content related to the travel poster 414. In various implementations, the electronic device detects the text printed on the travel poster 414. In various implementations, the text (e.g., “PlaceBand”) alternatively refers to a band or a place. In response to determining that the text is printed on an object having an object type of “travel poster”, the electronic device identifies content relating to the place named “PlaceBand” rather than the band named “PlaceBand”.

FIG. 4A illustrates a third content indicator 425 indicating that the electronic device has identified content related to the snack canister 415. In various implementations, the electronic device detects the text printed on the snack canister 415. In various implementations, the electronic device detects the barcode printed on the snack canister 415. In various implementations, the text (e.g., “AnimalFood”) alternatively refers to an animal or food named after the animal, e.g., a cracker in the shape of the animal. In response to determining that the text is printed on an object having an object type of “snack canister” or “food container”, the electronic device identifies content relating to the food named “AnimalFood” rather than the animal named “AnimalFood”.

FIG. 4A illustrates a fourth content indicator 426 indicating that the electronic device has identified content related to the book 426. In various implementations, the electronic device detects the text printed on the book 416. In various implementations, the text (e.g., “AnimalFood”) alternatively refers to an animal or food named after the animal, e.g., a cracker in the shape of the animal In response to determining that the text is printed on an object having an object type of “book”, the electronic device identifies content relating to the animal named “AnimalFood” rather than the food named “AnimalFood”.

The XR environment 400 includes a gaze direction indicator 450 that indicates a gaze direction of the user, e.g., where in the XR environment 400 the user is looking. Although the gaze direction indicator 450 is displayed in FIGS. 4A-4J, in various implementations, the gaze direction indicator 450 is not displayed. During the first time period, the gaze direction indicator 450 is displayed over a portion the wall 411 indicating that the user is looking at the wall 411 during the first time period.

FIG. 4B illustrates the XR environment 400 during a second time period subsequent to the first time period. In various implementations, the second time period is an instant, a fraction of a second, a few seconds, a few hours, a few days, or any length of time. During the second time period, the gaze direction indicator 450 is displayed over the first content indicator 423.

FIG. 4C illustrates the XR environment 400 during a third time period subsequent to the second time period. In various implementations, the third time period is an instant, a fraction of a second, a few seconds, a few hours, a few days, or any length of time. During the third time period, the first content indicator 423 is replaced with a first content window 433. In various implementations, the first content indicator 423 is activated, e.g., replaced with the first content window 433, in response to a trigger. For example, in various implementations, the first content indicator 423 is activated in response to a user input directed to the first content indicator 423. For example, in various implementations, the user input directed to the first content indicator 423 includes the user gazing at the first content indicator 423 and snapping, winking, or speaking an activation command In various implementations, the first content indicator 423 is activated in response to determining that the user has gazed at the first content indicator 423 (or the record album 413 with which the first content indicator 423 is associated) for at least a threshold amount of time.

The first content window 433 includes content regarding the band named “PlaceBand”. The first content window 433 includes first informational content 443A including text, images, or other consumable media. The first content window 433 includes a more information affordance 443B which, when selected, causes the electronic device to display additional content, such as an online encyclopedia article. The first content window 433 includes a play music affordance 443C which, when selected, causes the electronic device to play music by the band named “PlaceBand” (or causes the electronic device to instruct another electronic device, such as a speaker, to play music by the band named “PlaceBand”). In various implementations, the play music affordance 443C is selected for display based on the object type of the object, e.g., the record album 413.

During the third time period, the gaze direction indicator 450 is displayed over the play music affordance 443C.

FIG. 4D illustrates the XR environment 400 during a fourth time period subsequent to the third time period. In various implementations, the fourth time period is an instant, a fraction of a second, a few seconds, a few hours, a few days, or any length of time.

During the fourth time period, in response to activation of the play music affordance 443C during the third time period, the electronic device (or another instructed electronic device) plays music by the band named “PlaceBand”.

During the fourth time period, the gaze direction indicator 450 is displayed over the travel poster 414.

FIG. 4E illustrates the XR environment 400 during a fifth time period subsequent to the fourth time period. In various implementations, the fifth time period is an instant, a fraction of a second, a few seconds, a few hours, a few days, or any length of time. During the fifth time period, the second content indicator 424 is activated and replaced with a second content window 434.

The second content window 434 includes content regarding the place named “PlaceBand”. The second content window 434 includes second informational content 444A including text, images, or other consumable media. The second content window 434 includes a more affordance 444B which, when selected, causes the electronic device to display additional content, such as an online encyclopedia article. The second content window 434 includes a show map affordance 444C which, when selected, causes the electronic device to display a map of the place named “PlaceBand”. In various implementations, the show map affordance 444C is selected for display based on the object type of the object, e.g., the travel poster 414.

During the fifth time period, the gaze direction indicator 450 is displayed over the show map affordance 444C.

FIG. 4F illustrates the XR environment 400 during a sixth time period subsequent to the fifth time period. In various implementations, the sixth time period is an instant, a fraction of a second, a few seconds, a few hours, a few days, or any length of time. During the sixth time period, in response to activation of the show map affordance 444C during the fifth time period, the second content window 434 includes a map of the place named “PlaceBand”.

During the sixth time period, the gaze direction indicator 450 is displayed over the snack canister 415.

FIG. 4G illustrates the XR environment 400 during a seventh time period subsequent to the sixth time period. In various implementations, the seventh time period is an instant, a fraction of a second, a few seconds, a few hours, a few days, or any length of time. During the seventh time period, the third content indicator 425 is activated and replaced with a third content window 435.

The third content window 435 includes content regarding the food named “AnimalFood”. The third content window 435 includes third informational content 445A including text, images, or other consumable media. The third content window 435 includes a more affordance 445B which, when selected, causes the electronic device to display additional content, such as an online encyclopedia article. The third content window 435 includes an order more affordance 445C which, when selected, causes the electronic device to place an electronic shopping order for the food named “AnimalFood” for delivery to the user. In various implementations, the order more affordance 445C is selected for display based on the object type of the object, e.g., the snack canister 415.

During the seventh time period, the gaze direction indicator 450 is displayed over the order more affordance 445C.

FIG. 4H illustrates the XR environment 400 during an eighth time period subsequent to the seventh time period. In various implementations, the eighth time period is an instant, a fraction of a second, a few seconds, a few hours, a few days, or any length of time. During the eighth time period, in response to activation of the order more affordance 445C during the seventh time period, the electronic device places an order for the food named “AnimalFood” using default shipping and payment options. In various implementations, in response to activation of the order more affordance 445C, a user interface allowing the user to order the food named “AnimalFood” (e.g., an online shopping website) is presented.

During the eighth time period, the gaze direction indicator 450 is displayed over the book 416.

FIG. 4I illustrates the XR environment 400 during a ninth time period subsequent to the eighth time period. In various implementations, the ninth time period is an instant, a fraction of a second, a few seconds, a few hours, a few days, or any length of time. During the ninth time period, the fourth content indicator 426 is activated and replaced with a fourth content window 436.

The fourth content window 436 includes content regarding the animal named “AnimalFood”. The fourth content window 436 includes fourth informational content 446A including text, images, or other consumable media. The fourth content window 436 includes a more affordance 446B which, when selected, causes the electronic device to display additional content, such as an online encyclopedia article. The fourth content window 436 includes an instantiate pet affordance 446C which, when selected, causes the electronic device to display a virtual animal of the “AnimalFood” type. In various implementations, the instantiate pet affordance 446C is selected for display based on the object type of the object, e.g., the book 416.

During the ninth time period, the gaze direction indicator 450 is displayed over the instantiate pet affordance 446C.

FIG. 4J illustrates the XR environment 400 during a tenth time period subsequent to the ninth time period. In various implementations, the tenth time period is an instant, a fraction of a second, a few seconds, a few hours, a few days, or any length of time. During the tenth time period, in response to activation of the instantiate pet affordance 446C during the ninth time period, the electronic device displays a virtual animal 460. In various implementations, the virtual animal 460 interacts with the XR environment 400, e.g., with one or more objects within the XR environment 400. For example, in various implementations, the virtual animal 460 sits on the table. In various implementations, the virtual animal 460 is associated with various objectives and interacts with the XR environment to further those objectives. For example, in various implementations, the virtual animal 460 is associated with an objective to eat food and is attracted by the snack canister 415.

During the tenth time period, the gaze direction indicator 450 is displayed over the wall 411.

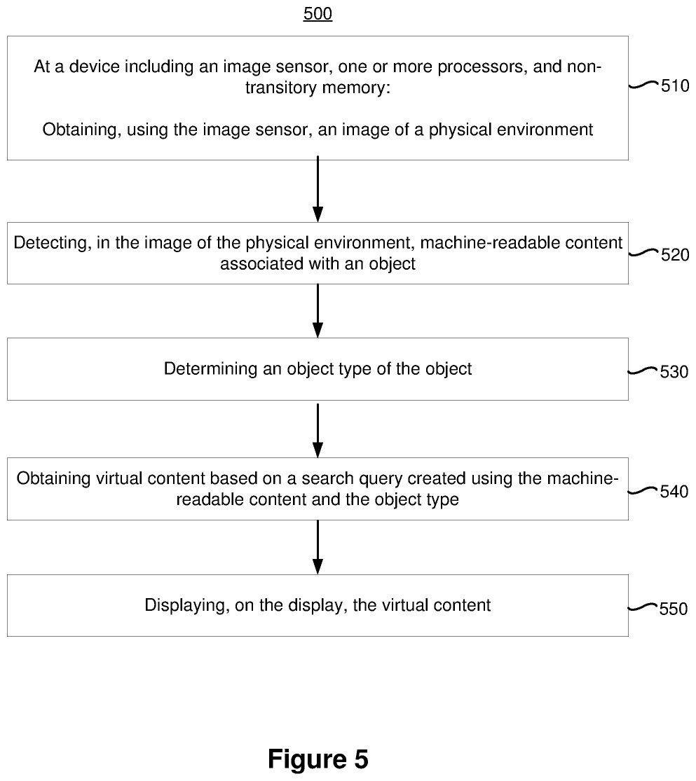

FIG. 5 is a flowchart representation of a method 500 of presenting virtual content in accordance with some implementations. In various implementations, the method 500 is performed by a device with an image sensor, one or more processors, and non-transitory memory (e.g., the electronic device 120 of FIG. 3). In some implementations, the method 500 is performed by processing logic, including hardware, firmware, software, or a combination thereof. In some implementations, the method 500 is performed by a processor executing instructions (e.g., code) stored in a non-transitory computer-readable medium (e.g., a memory).

The method 500 begins, in block 510, with the device obtaining, using the image sensor, an image of a physical environment. For example, FIG. 4A illustrates an XR environment 400 based on an image of a physical environment including a record album 413, a travel poster 414, a snack canister 415, and a book 416.

The method 500 continues, in block 520, with the device detecting, in the image of the physical environment, machine-readable content associated with an object. In various implementations, the machine-readable content includes text, a one-dimensional barcode, or a two-dimensional barcode. For example, FIG. 4A illustrates text reading “PlaceBand” on the record album 413, text reading “PlaceBand” on the travel poster 414, text reading “AnimalFood” on the snack canister 415, a one-dimensional barcode on the snack canister 415, and text reading “AnimalFood” on the book 416.

In various implementations, the machine-readable content is printed on the object. Thus, in various implementations, the machine-readable content is detected in a region of the image within a region of the image in which the object is represented. In various implementations, the machine-readable content is displayed next to the object. For example, at a store, a label including machine-readable content identifying the object for sale may be displayed on a shelf or container containing the object (or multiple instances of the object). Thus, in various implementations, the machine-readable content is detected in a region of the image proximate to the region of the image in which the object is represented. In various implementations, the machine-readable content is associated with the object via a key or legend. In various implementations, the machine-readable content is associated with the object via an arrow or lead line.

The method 500 continues, in block 530, with the device determining an object type of the object. In various implementations, determining the object type of the object is based on a size or shape of the object. For example, various media containers, such as video cassettes, compact discs cases, or record album covers are produced with standardized dimensions. Accordingly, in various implementations, the device determines the object type by comparing dimensions of the object to sets of dimensions.

In various implementations, determining the object type includes classifying the object using a neural network. For example, in various implementations, the device applies a neural network to a region of the image representing the object to generate a label indicating the object type.

In various implementations, the neural network includes an interconnected group of nodes. In various implementation, each node includes an artificial neuron that implements a mathematical function in which each input value is weighted according to a set of weights and the sum of the weighted inputs is passed through an activation function, typically a non-linear function such as a sigmoid, piecewise linear function, or step function, to produce an output value. In various implementations, the neural network is trained on training data to set the weights.

In various implementations, the neural network includes a deep learning neural network. Accordingly, in some implementations, the neural network includes a plurality of layers (of nodes) between an input layer (of nodes) and an output layer (of nodes). In various implementations, the neural network receives, as inputs, at least a region of the image representing the object. In various implementations, the neural network provides, as an output, a label indicating the object type.

In various implementations, the neural network is trained for a variety of object types. For each object type, training data in the form of image data representing the object type is provided. Thus, the neural network is trained with many different data sets of different books to train the neural network to detect a book. Similarly, the neural network is trained with many different data sets to train the neural network to detect a record album.

In various implementations, the neural network includes a plurality of neural network detectors, each trained for a different object type. Each neural network detector, trained on data of the object type, provides, as an output, a probability that a particular data set includes the particular object type. Thus, in response to receiving a data set, a neural network detector for an object type of record album may output a probability of 0.2 and a neural network detector for an object type of book may output a probability of 0.9. The label for the particular object is determined based on the greatest output breaching a threshold.

In various implementations, the object type is specified with varying degrees of specificity. For example, in various implementations, the object type is “record album”, “compact disc”, “cereal box”, or “potato chip can”, whereas, in various implementations, the object type is “music-related” (which encompasses various types of objects, such as record albums, compact discs, and/or cassette tapes) or “food-related” (which encompasses various types of objects, such as cereal boxes, potato chip cans, snack mix bags, and/or canned goods).

In various implementations, the device determines the object type based on image analysis of other content associated with (e.g., printed on) the object. For example, in FIG. 4A, the device distinguishes the object type of the travel poster 414 between a travel poster referring to a place named “PlaceBand” and a concert poster referring to a band named “PlaceBand” by analyzing the image of the poster. For example, if a musical instrument is detected on the poster, the device determines the object type as “music-related” whereas if a landscape is detected on the poster, the device determines the object type as “place-related”.

In various implementations, the device determines the object type based on the machine-readable content. For example, in various implementations, the machine-readable content alternatively refers to a finite set of subjects. Thus, the device determines the object type as associated with one of the finite set of subjects. For example, in FIG. 4A, the text “AnimalFood” alternatively refers to an animal or food named after the animal, e.g., a cracker in the shape of the animal. Accordingly, the device determines the object type as one of “animal-related” or “food-related”.

The method 500 continues, in block 540, with the device obtaining virtual content based on a search query created using the machine-readable content and the object type. For example, in FIG. 4A, the electronic device detects the machine-readable content of “AnimalFood” on the snack canister 415, determines an object type of “food container” for the snack canister 415, and generates a search query of “AnimalFood food”.

In various implementations, the obtaining the virtual content based on the search query includes creating the search query using the machine-readable content and the object type, transmitting the search query to a server, and receiving content in response to the search query. In various implementations, obtaining the virtual content based on the search query includes transmitting the machine-readable content and the object type to a server and receiving content in response to a search query created by the server using the machine-readable content and the object type. In various implementations, the search query is created by determining a plurality of search queries based on the machine-readable content and selecting the search query from the plurality of search queries based on the object type. In various implementations, the device generates the virtual content, such as a content window, based on the content received from the server. For example, in FIG. 4C, the device displays the first content window 433 including the first informational content 443A.

In various implementations, the search query is generated by determining a plurality of search queries based on the machine-readable content and selecting the search query from the plurality of search queries based on the object type. For example, in FIG. 4A, the electronic device detects the machine-readable content of “PlaceBand” on the record album 413 and determines a plurality of search queries including “PlaceBand country”, “PlaceBand band”, and “PlaceBand novel”. Based on the object type of “record album” for the record album 413, the electronic device selects the search query as “PlaceBand band”.

In various implementations, the search query includes selecting a database based on the object type. For example, in various implementations, the device selects a database of music files based on a “music-related” object type and selects a database of shopping websites based on a “food-related” object type.

As another example, the electronic device detects machine-readable content of “AmbiguousName” on a table, where “AmbiguousName” alternatively refers to a furniture maker or a type of flower. The electronic device determines an object type of “table” or “furniture” for the table and generates a search query of “AmbiguousName furniture”.

As another example, the electronic device detects machine-readable content of “ProperName” on an object, where “ProperName” is the shared name of two different people, a basketball star and an author. In various implementations, the electronic device determines an object type of “book” for the object and generates a search query of “ProperName author”. In various implementations, the electronic device determines an object type of “poster” for the object and generates a search query of “ProperName basketball”.

The method 500 continues, in block 550, with the device displaying the virtual content. In various implementations, the content obtained by the device includes consumable media related to the subject of the search query, such as text, audio, images, and/or video. For example, in FIG. 4E, the second content window 434 includes the second informational content 444A regarding the place named “PlaceBand”. As another example, in FIG. 4C, the first content window 433 includes the play music affordance 443C associated with audio created by the band named “PlaceBand”. In various implementations, the content obtained by the device includes one or more websites (either the content thereof or links thereto) related to the subject to the search query. For example, in FIG. 4C, the first content window 433 includes the more information affordance 443B linking to a website regarding the band named “PlaceBand”. As another example, in FIG. 4G, the third content window 435 includes the order more affordance 445C linking, in various implementations, to a website for ordering the food named “AnimalFood”. In various implementations, the content obtained by the device includes XR content. In various implementations, XR content is displayed based on the physical environment. In various implementations, the XR content is displayed on a surface of the physical environment. In various implementations, the XR content is displayed interacting with the physical environment. For example, in FIG. 4I, the fourth content window 436 includes the instantiate pet affordance 446C for displaying a virtual animal 460.

In various implementations, the device displays the virtual content in association with the physical environment. In various implementations, the display is an opaque display and the virtual content is displayed in association with the physical environment as a composite image of the virtual content and an image of the physical environment. Thus, in various implementations, displaying the virtual content includes displaying, based on the image of the physical environment, an image representation of the physical environment including the virtual content. In various implementations, the display is a transparent display and the virtual content is displayed in association with the physical environment as a projection over a view of the physical environment.

In various implementations, the device displays the virtual content in association with the object. For example, in FIG. 4C, the first content window 433 is displayed next to the record album 413. As another example, in FIG. 4E, the second content window 434 is displayed next to the travel poster 414.

In various implementations, the device displays the virtual content by displaying an affordance to perform an action based on the search query. For example, in FIG. 4C, the first content window 433 includes the more information affordance 443B for presenting additional consumable media regarding the band named “PlaceBand” and the play music affordance 443C for playing music by the band named “PlaceBand”.

In various implementations, the device displays a content indicator and displays the virtual content in response to detecting activation of the content indicator. For example, in FIG. 4A, the electronic device displays the first content indicator 423 in association with the record album 413, in FIG. 4B, detects activation of the first content indicator 423, and, in FIG. 4C, displays the first content window 433 in association with the record album 413.

While various aspects of implementations within the scope of the appended claims are described above, it should be apparent that the various features of implementations described above may be embodied in a wide variety of forms and that any specific structure and/or function described above is merely illustrative. Based on the present disclosure one skilled in the art should appreciate that an aspect described herein may be implemented independently of any other aspects and that two or more of these aspects may be combined in various ways. For example, an apparatus may be implemented and/or a method may be practiced using any number of the aspects set forth herein. In addition, such an apparatus may be implemented and/or such a method may be practiced using other structure and/or functionality in addition to or other than one or more of the aspects set forth herein.

It will also be understood that, although the terms “first,” “second,” etc. may be used herein to describe various elements, these elements should not be limited by these terms. These terms are only used to distinguish one element from another. For example, a first node could be termed a second node, and, similarly, a second node could be termed a first node, which changing the meaning of the description, so long as all occurrences of the “first node” are renamed consistently and all occurrences of the “second node” are renamed consistently. The first node and the second node are both nodes, but they are not the same node.

The terminology used herein is for the purpose of describing particular implementations only and is not intended to be limiting of the claims. As used in the description of the implementations and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

As used herein, the term “if” may be construed to mean “when” or “upon” or “in response to determining” or “in accordance with a determination” or “in response to detecting,” that a stated condition precedent is true, depending on the context. Similarly, the phrase “if it is determined [that a stated condition precedent is true]” or “if [a stated condition precedent is true]” or “when [a stated condition precedent is true]” may be construed to mean “upon determining” or “in response to determining” or “in accordance with a determination” or “upon detecting” or “in response to detecting” that the stated condition precedent is true, depending on the context.

What is claimed is:

1. A method comprising:
at a device comprising an image sensor, one or more processors, and a memory:
obtaining, using the image sensor, an image of a physical environment;
detecting, in the image of the physical environment, machine-readable content associated with an object;
determining an object type of the object;
obtaining virtual content based on a search query created using the machine-readable content and the object type; and
displaying the virtual content.

2. The method of claim 1, wherein the machine-readable content includes at least one of text, a one-dimensional barcode, or a two-dimensional barcode.

3. The method of claim 1, wherein determining the object type is based on a size or a shape of the object.

4. The method of claim 1, wherein determining the object type includes classifying the object using a neural network.

5. The method of claim 1, wherein obtaining the virtual content based on the search query includes:
creating the search query using the machine-readable content and the object type;
transmitting the search query to a server; and
receiving content in response to the search query.

6. The method of claim 1, wherein obtaining the virtual content based on the search query includes:
transmitting the machine-readable content and the object type to a server; and
receiving content in response to a search query created by the server using the machine-readable content and the object type.

7. The method of claim 1, wherein the search query is created by:
determining a plurality of search queries based on the machine-readable content; and
selecting the search query from the plurality of search queries based on the object type.

8. The method of claim 1, wherein the virtual content includes at least one of text, audio, images, or video.

9. The method of claim 1, wherein the virtual content includes one or more websites.

10. The method of claim 1, wherein the virtual content includes three-dimensional content.

11. The method of claim 1, wherein displaying the virtual content includes displaying the virtual content in association with the physical environment.

12. The method of claim 1, wherein displaying the virtual content includes displaying the virtual content in association with the object.

13. The method of claim 1, wherein displaying the virtual content includes displaying an affordance to perform an action based on the search query.

14. The method of claim 1, wherein displaying the virtual content includes displaying a content indicator and, in response to detecting activation of the content indicator, displaying the virtual content.

15. The method of claim 14, wherein detecting activation of the content indicator include detecting a gaze of the user directed at the content indicator or the object.

16. A device comprising:
an image sensor;
a non-transitory memory; and
one or more processors to:
obtain, using the image sensor, an image of a physical environment;
detect, in the image of the physical environment, machine-readable content associated with an object;
determine an object type of the object;
obtain virtual content based on a search query created using the machine-readable content and the object type; and
display the virtual content.

17. The device of claim 16, wherein the one or more processors are to obtain the virtual content based on the search query by:
creating the search query using the machine-readable content and the object type;
transmitting the search query to a server; and
receiving content in response to the search query.

18. The device of claim 16, wherein the one or more processors are to obtain the virtual content based on the search query by:
transmitting the machine-readable content and the object type to a server; and
receiving content in response to a search query created by the server using the machine-readable content and the object type.

19. The device of claim 16, wherein the search query is created by:
determining a plurality of search queries based on the machine-readable content; and
selecting the search query from the plurality of search queries based on the object type.

20. A non-transitory memory storing one or more programs, which, when executed by one or more processors of a device with an image sensor, cause the device to:
obtain, using the image sensor, an image of a physical environment;
detect, in the image of the physical environment, machine-readable content associated with an object;
determine an object type of the object;
obtain virtual content based on a search query created using the machine-readable content and the object type; and
display the virtual content.
